(19) United States
(12) Patent Application Publication
(10) Pub. No.: US 2024/0232398 A1
(43) Pub. Date: Jul. 11, 2024

(54) Receiver with Enhanced Transmitter Compatibility and Method Therefore

(71) Applicant: KONINKLIJKE PHILIPS N.V., EINDHOVEN (NL)

(72) Inventor: Rene Debets, Hoensbroek (NL)

(21) Appl. No.: 18/563,473

(22) PCT Filed: May 25, 2022
(86) PCT No.: PCT/EP2022/064138

§ 371 Date: Nov. 22, 2023

Related U.S. Application Data
(60) Provisional application No. 63/194,101, filed on May 27, 2021.

(51) Int. Cl. G06F 21/60

(52) U.S. Cl. CPC G06F 21/606; G06F 2221/2103

(57) ABSTRACT

A receiver that is arranged to receive protected content from a variety of transmitter, some of the transmitters imposing a maximum response time between sending a challenge to the receiver and receiving a response from the receiver while other transmitters lack such a requirement, it is necessary that receivers remain compatible with both systems. To achieve this such a receiver comprises a processor, the processor comprising a challenge response generator, a communication receiver for receiving a challenge from the transmitter, and a communication transmitter for returning a response to the transmitter, the challenge response generator being arranged to receive the challenge from the communication receiver and to generate a response and to transmit the response to the communication transmitter after a response delay time, where the challenge response generator comprises a response delay control unit where the response delay control unit is arranged to control the response delay time. By providing different response times for successive responses the receiver can ensure that after a failure to provide the response in time one of the successive challenges can be responded to with a response time that allows the transmitter to continue operation and provide the protected content to the receiver.

### TECHNICAL FIELD OF THE INVENTION

The invention relates to a receiver arranged to receive protected content from a transmitter, the transmitter imposing a maximum response delay time between sending a challenge to the receiver and receiving a response from the receiver, the receiver comprising a processor, the processor comprising a challenge response generator.

a communication receiver for receiving a challenge from the transmitter and a communication transmitter for returning a response to the transmitter the challenge response generator being arranged to receive the challenge from the communication receiver and to generate a response and to transmit the response to the communication transmitter after a response delay time.

### BACKGROUND ART

Such a receiver is known from the Digital Content Protection LLC proprietary specification called HDCP 2.3 edition 2018 which is available from https://www.digital-cp.com/. In HDCP 2.3 a locality check is performed which imposes a maximum response delay time between sending a challenge to the receiver and receiving a response from the receiver.

A random number Rn is generated by the transmitter and sent to the receiver.

The receiver generates a response based on the challenge, in the case of HDCP 2.3 this challenge is a modification of the random number Rn based on a shared secret that has previously been shared by the transmitter and the receiver. The Receiver thus proves that it is in possession of the shared secret and that the response to the challenge really originated from the same receiver as the secret was shared with. The random number Rn is later used in the establishment of a secure authenticated channel. By imposing a time limit the transmitter complying with the 2018 HDCP 2.3 ensures that the receiver is local.

This locality check is in view of the technological developments and distribution of content via other channels that do not impose such a requirement on the location of the receiver no longer needed. Imposing a maximum response delay time is thus no longer a useful requirement and has been dropped.

These updated receivers however create a problem with a large installed base of transmitters and receivers.

When a updated receiver that no longer functions in a way that it provides the response to the challenge in time for transmitter still imposing the maximum response time requirement, the transmitter will determine a failure of the locality check and will not provide the content. This results in customer frustration.

Also, on the transmitter side, no longer having any requirement as to when a response to the challenge the transmitter sent has to be received result in system that stalls and will never recover. As such also a transmitter without a time based locality check will still have to require a maximum response delay time after which the locality check is deemed to have failed and a new locality check using a new Rn challenge can be initiated.

### DISCLOSURE OF THE INVENTION

In order to overcome these problems the challenge response generator in a receiver according to the invention comprises a response delay control unit where the response delay control unit is arranged to control the response delay time.

By having control over the response delay time the receiver provides responses with different, controllable response delay times.

For legacy transmitters that comply with the 2018 HDCP 2.3 specification, and thus require a short response delay time, the delay control unit reduces response delay times.

For updated transmitters that no longer use a time requirement in the locality check and thus only require a rather long response delay time the response delay control unit increases response delay times.

This way a receiver complying with new specification will still function with the installed base of transmitters complying with the old specification.

In a first embodiment a first response is associated with a first response delay time and a successive second response is associated with a second response delay time, the first and second response delay times differing from each other.

Different response delay times allow the receiver to correctly interact with both legacy transmitters and updated transmitters. If the first response delay time leads to a failure of the locality check by the transmitter, the transmitter will issue a new challenge. The receiver response delay control unit now selects a different response delay time and issue the response after the second response delay time. If the second response delay time is acceptable to the transmitter the transmitter will provide the content. Thus compatibility with different transmitters requiring different response delay times is achieved.

In a second embodiment the second response delay time differs the first response delay time by a minimum amount.

If multiple successive response delays differ by a minimum amount of time fewer attempts are needed before the response delay time complies with the maximum response delay requirement of legacy transmitters.

In a further embodiment the second response delay time differs the first response delay time by a random amount.

Using a random amount ensures a distribution of response delay times over a range thus providing response delay times compliant with the requirements of both updated transmitters and of legacy transmitters.

In an embodiment a distribution of response delay times is a gaussian distribution. By selecting a gaussian distribution a receiver can be made to have a higher probability to connect to either a legacy transmitter or an updated transmitter. This results in a faster connection as the required response delay time occurs more frequently at the peak of the gaussian distribution than at a tail of the gaussian distribution

In yet a further embodiment the response delay time is between a minimum response delay time and a maximum response delay time. The minimum response delay time can be chosen to comply with the requirements of the legacy transmitter while the maximum time can be chosen to avoid a system stall due to a lack of time out on the transmitter side.

In an embodiment the minimum response delay time is below the maximum response delay time imposed by the transmitter.

While the minimum response delay time is selected infrequently or randomly, ensuring that at least occasional the response delay time selected Is below the maximum response delay time imposed by the transmitter ensures that a legacy transmitter will be able to perform a valid locality check where the response delay time is below the maximum response delay time as required by the legacy transmitter. This way also updated receivers will still work with legacy transmitters, albeit more locality challenges may be required before compliance is achieved.

In an embodiment a predetermined percentage of response delay times is below the maximum response delay time imposed by the transmitter.

By imposing a distribution between response delay time the delay caused by legacy transmitter locality check failures can be adjusted. This allows the optimization of the connection delays based on market penetration of updated transmitters. When mostly legacy transmitters are in the field the frequency of occurrence of short response delay times is chosen higher than the frequency of occurrence of longer response delay times, thus ensuring increasing the chance of the response delay time being in compliance with the transmitter response delay time requirements.

When time progresses and legacy transmitters are outnumbered by updated transmitters the frequency of longer.

A method to receive protected content from a transmitter,
the transmitter imposing a maximum response delay time between sending a challenge and receiving a response.
comprising the steps of
receiving a challenge from the transmitter
generating a response; and
transmitting the response to transmitter after a response delay time.
The method further comprising the step of
controlling the response delay time.

By having control over the response delay time the receiver provides responses with different, controllable response delay times.

For legacy transmitters that comply with the 2018 HDCP 2.3 specification, and thus require a short response delay time, the response delay control unit reduces response delay times.

For updated transmitters that no longer use a time requirement in the locality check and thus only require a rather long response delay time the response delay control unit allows longer response delay times.

This way a receiver complying with new specification will still function with the installed base of transmitters complying with the old specification.

In an embodiment of the method a first response is associated with a first response delay time and a second response is associated with a second response delay time, the first and second response delay times differing from each other.

Different response delay times allow the receiver to correctly interact with both legacy transmitters and updated transmitters. If the first response delay time leads to a failure of the locality check by the transmitter, the transmitter will issue a new challenge. The receiver response delay control unit now selects a different response delay time and issue the response after the second response delay time. If the second response delay time is acceptable to the transmitter the transmitter will provide the content. Thus compatibility with different transmitters requiring different response delay times is achieved.

In another embodiment of the method the second response delay time differs the first response delay time by a minimum amount.

If multiple successive response delays differ by a minimum amount of time fewer attempts are needed before the response delay time complies with the maximum response delay requirement of legacy transmitters.

In yet another embodiment the second response delay time differs the first response delay time by a random amount.

Using a random amount ensures a distribution of response delay times over a range thus providing response delay times compliant with the requirements of both updated transmitters and of legacy transmitters.

In a further embodiment of the method a distribution of response delay times is a gaussian distribution.

By selecting a gaussian distribution a receiver can be made to have a higher probability to connect to either a legacy transmitter or an updated transmitter. This results in a faster connection as the required response delay time occurs more frequently at the peak of the gaussian distribution than at a tail of the gaussian distribution

In a further embodiment of the method the response delay time is between a minimum response delay time and a maximum response delay time. The minimum delay time can be chosen to comply with the requirements of the legacy transmitter while the maximum time can be chosen to avoid a system stall due to a lack of time out on the transmitter side.

In a further embodiment of the method the minimum response delay time is below the maximum response delay time imposed by the transmitter.

While the minimum response delay time is selected infrequently or randomly, ensuring that at least occasional the response delay time selected Is below the maximum response delay time imposed by the transmitter ensures that a legacy transmitter will be able to perform a valid locality check where the response delay time is below the maximum response delay time as required by the legacy transmitter. This way also updated receivers will still work with legacy transmitters, albeit more locality challenges may be required before compliance is achieved.

In another embodiment of the method a predetermined percentage of response delay times is below the maximum response delay time imposed by the transmitter.

By imposing a distribution between response delay time the connection delay caused by legacy transmitter locality check failures can be adjusted. This allows the optimization of the connection delays based on market penetration of updated transmitters. When mostly legacy transmitters are in the field the frequency of occurrence of short response delay times is chosen higher than the frequency of occurrence of longer response delay times, thus ensuring increasing the chance of the response delay time being in compliance with the transmitter response delay time requirements.

When time progresses and legacy transmitters are outnumbered by updated transmitters the frequency of longer.

### BRIEF DESCRIPTION OF THE DRAWINGS

FIG. 1 shows a legacy transmitter and a legacy receiver.

FIG. 2 shows an updated transmitter and an updated receiver.

FIG. 3 shows a timing diagram of a legacy locality check.

FIG. 4 shows a timing diagram of an updated locality check.

FIG. 5 shows a timing diagram of a locality check between a legacy transmitter and an updated receiver.

FIG. 6 shows a receiver according to the invention.

FIG. 7 shows a timing diagram of a locality check between a legacy transmitter and a receiver according to the invention.

FIG. 8 shows a timing diagram of a locality check between an updated transmitter and a receiver according to the invention.

FIG. 9 shows a distribution of response times including a uniformly distribution of response delay times.

FIG. 10 shows the steps of a receiver method according to the invention.

### MODES FOR CARRYING OUT THE INVENTION

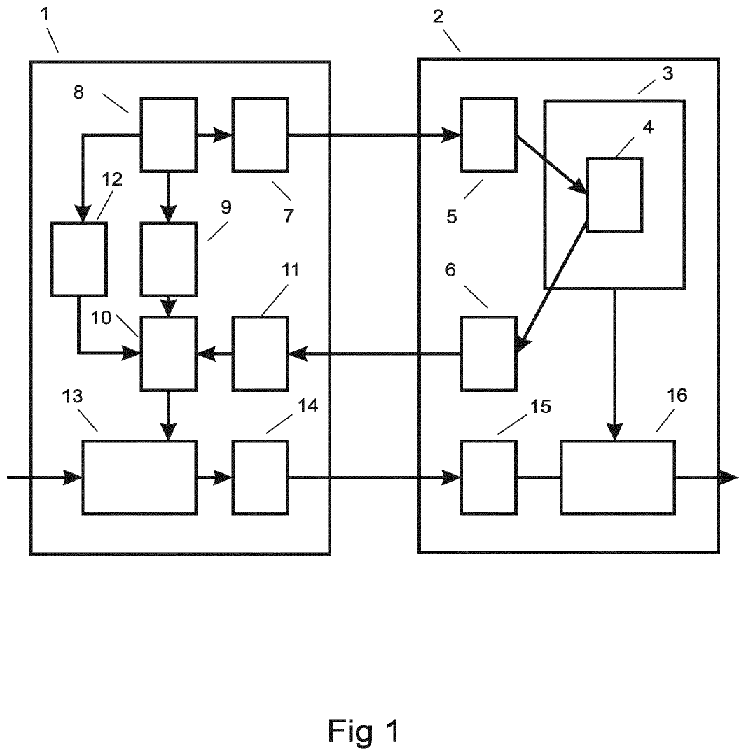

FIG. 1 shows a legacy transmitter and a legacy receiver.

A legacy receiver 2 is arranged to receive protected content from a legacy transmitter 1, the legacy transmitter 1 imposing a maximum response delay time between sending a challenge to the legacy receiver 2 and receiving a response from the legacy receiver 2.

In order to be able to provide a response to the challenge the legacy receiver 2 comprises a processor 3. This processor can be a general purpose processor with associated circuitry to control the receiver or can be, again with the required external circuitry, be arranged to control the challenge response process.

The processor comprises a challenge response generator 4. This challenge response generator 4 receives from the receiver's communication receiver circuit 5 the challenge as transmitted by the transmitter 1 using a transmitter's communication transmission circuit 7 to transmit a random number as generated by a random number generator 8 which is also comprised in the transmitter 1.

After receiving the challenge the challenge response generator 4 calculates a response. This response can for instance be a modification of the challenge received using a secret that is shared known to both transmitter 1 and receiver 2. This calculation takes a certain amount of time, after which the challenge response generator provides the response to the receiver's transmission communication circuit 6, which in turn transmits the response to the legacy transmitter 1. The legacy transmitter 1 receives the response via transmitter's communication receiving circuit 11. While the challenge was sent to the legacy receiver 2, the legacy transmitter performed the same calculation as the legacy receiver's 2 challenge response unit 4. The result of this local calculation performed in the legacy transmitter is provided just as well as the received response to a locality verification unit 10. This locality verification unit 10 performs two functions. It verifies that the locally calculated result is equal to the received response and that the received response was received within a predetermined time. A timer 12 provides timing information to the locality verification unit 10. The timer is started when the challenge is transmitted by the legacy transmitter 1 and is either stopped of compared against when the response has been received by the legacy transmitter 1.

If both conditions are met the locality verification unit 10 enables the provision of protected content by the legacy transmitter 1 to the legacy receiver 2.

To this end the protected content is received by the transmitter 1 and encrypted by an encryptor 13. After encryption the protected content is transmitted to the receiver using the transmitter's content transmitter circuitry 14. The receiver 2 where it is received by the receiver's content receiver circuitry 15 which in turn provides the protected content to a decryptor 16 where the protected content is decrypted for further use.

As the challenge can comprise a random number, this random number can be used during encryption and decryption of the protected content.

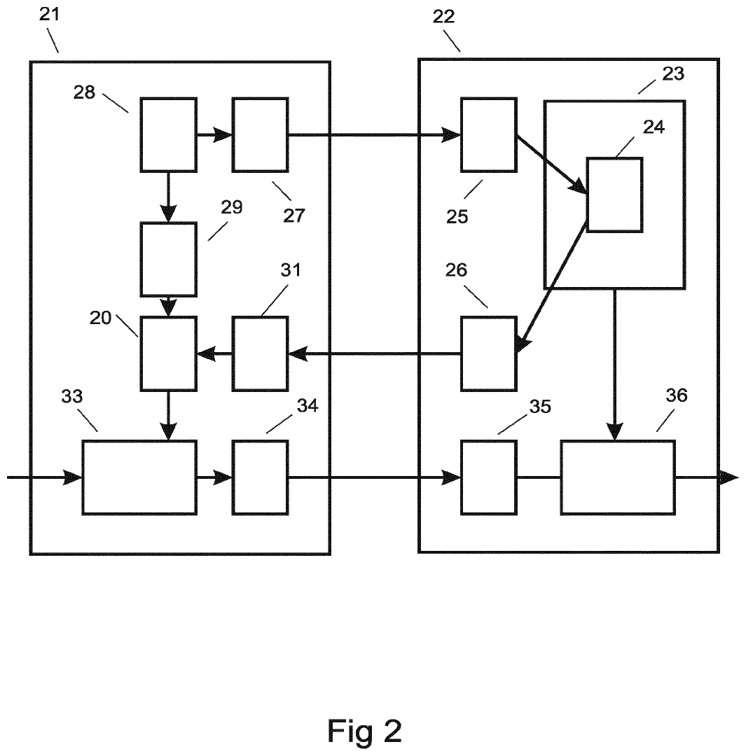

FIG. 2 shows a updated transmitter and an updated receiver.

An updated receiver 22 is arranged to receive protected content from a updated transmitter 1, the updated transmitter 21 imposing a maximum response delay time between sending a challenge to the updated receiver 22 and receiving a response from the updated receiver 22.

In order to be able to provide a response to the challenge the updated receiver 22 comprises a processor 3. This processor can be a general purpose processor with associated circuitry to control the receiver or can be, again with the required external circuitry, be arranged to control the challenge response process.

The processor comprises a challenge response generator 24. This challenge response generator 24 receives from the receiver's communication receiver circuit 25 the challenge as transmitted by the transmitter 21 using a transmitter's communication transmission circuit 27 to transmit a random number as generated by a random number generator 28 which is also comprised in the transmitter 21.

After receiving the challenge the challenge response generator 4 calculates a response. This response can for instance be a modification of the challenge received using a secret that is shared known to both transmitter 21 and receiver 22. This calculation takes a certain amount of time, after which the challenge response generator provides the response to the receiver's transmission communication circuit 26, which in turn transmits the response to the updated transmitter 21. The updated transmitter 21 receives the response via transmitter's communication receiving circuit 11. While the challenge was sent to the updated receiver 22, the updated transmitter performed the same calculation as the updated receiver's 22 challenge response unit 24. The result of this local calculation performed in the updated transmitter is a locally generated response that is then provided just as well as the received response to a locality verification unit 30. This locality verification unit 30 performs a single function. It verifies that the locally calculated response is equal to the received response and does not check that the received response was received within a predetermined time. As such the locality verification unit will not time out. The operation of the transmitter 21 will stall in this state.

If a correct response has been received the locality verification unit 30 enables the provision of protected content by the updated transmitter 21 to the updated receiver 22.

To this end the protected content is received by the transmitter 21 and encrypted by an encryptor 33. After encryption the protected content is transmitted to the receiver using the transmitter's content transmitter circuitry 34. The receiver 22 where it is received by the receiver's content receiver circuitry 35 which in turn provides the protected content to a decryptor 36 where the protected content is decrypted for further use.

As the challenge can comprise a random number, this random number can be used during encryption and decryption of the protected content.

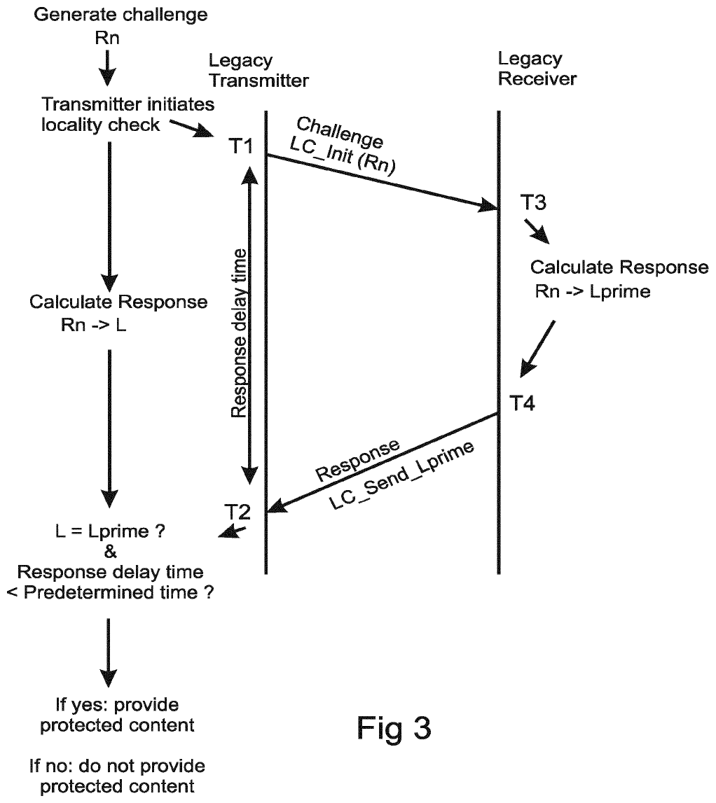

FIG. 3 shows a timing diagram of a legacy locality check.

FIG. 3 shows the behavior of the legacy transmitter on the left and the legacy receiver on the right.

The transmitter first generates a challenge, for instance a random number Rn. and at time T1 transmits this challenge to the receiver, for instance using the command LC_INIT comprising the Random number Rn. This challenge is received by the receiver at time T3 and the receiver's challenge response generator starts calculating a response. This response can for instance be a modification of the random number Rn using a secret that previously has been shared between the transmitter and the receiver. In parallel the transmitter will generate a local response by performing the same calculations as the receiver's challenge response generator. As soon as the receiver's challenge response generator has calculated the response this response is sent to the transmitter indicated by time T4 in FIG. 3. After the transmitter receives the response at time T2, for instance via LC_Send_Lprime, it compares the received response to the locally generated response. In addition the locality verification unit will check whether the response was received within the predetermined time limit. i.e. whether T2-T1<predetermined time limit. If the locally generated response and received response are identical, and the response was received within the predetermined time limit, the transmitter continues and provides the protected content to the receiver.

If the locally generated response and received response are not identical and/or the predetermined time has been exceeded, the transmitter retries the locality check by generating a new Rn and sending it a new challenge to the receiver. It will in this case not provide the protected content to the receiver. If no response is received the system will time out based on the predetermined time and a new challenge is sent to the receiver. For a complete description of such a legacy system the document “High bandwidth Digital Content Protection System. Mapping HDCP to HDMI. Revision 2.3 Dated 28 Feb. 2018, section 2.3 Locality check on pages 16 and 17 is included by reference.

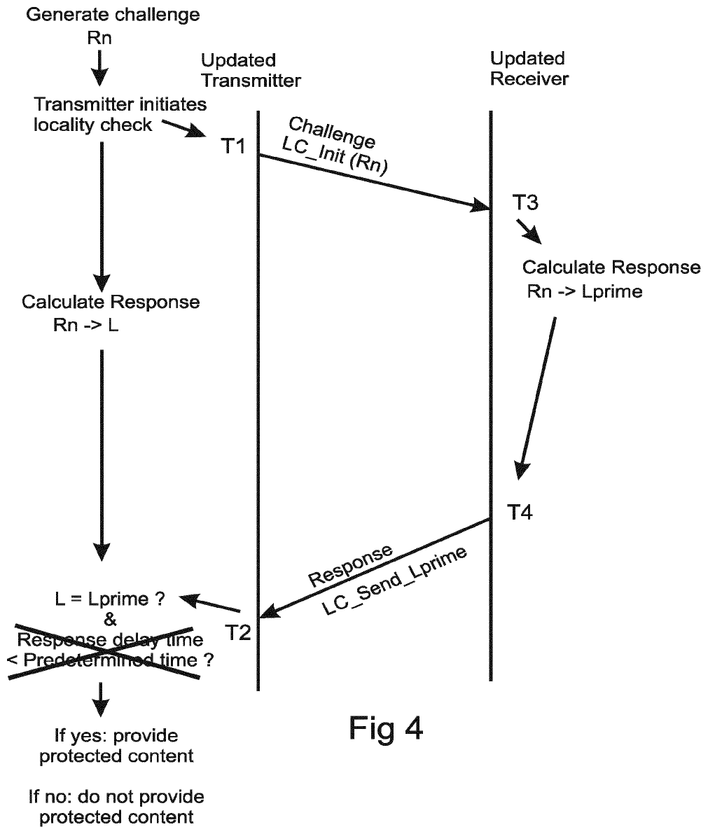

FIG. 4 shows a timing diagram of an updated locality check.

FIG. 4 shows the behavior of the updated transmitter on the left and the updated receiver on the right.

The transmitter first generates a challenge, for instance a random number Rn. and at time T1 transmits this challenge to the receiver, for instance using the command LC_INIT comprising the Random number Rn. This challenge is received by the receiver at time T3 and the receiver's challenge response generator starts calculating a response. This response can for instance be a modification of the random number Rn using a secret that previously has been shared between the transmitter and the receiver. In parallel the transmitter will generate a local response by performing the same calculations as the receiver's challenge response generator. As soon as the receiver's challenge response generator has calculated the response this response is sent to the transmitter indicated by time T4 in FIG. 4. After the transmitter receives the response it compares the received response to the locally generated response. If the locally generated response and received response are identical the transmitter continues and provides the protected content to the receiver. If the locally generated response and received response are not identical the transmitter retries the locality check by generating a new Rn and sending it a new challenge to the receiver. It will in this case not provide the protected content to the receiver. If no response is received the system will stall as the predetermined time is not checked anymore. In this configuration the receiving time of the response by the transmitter T2 is of no importance anymore, allowing relaxed processing times to calculate the response from the challenge but introducing problems in the form of a system that might stall in the state of waiting for a response from the receiver as no internal time-out exists.

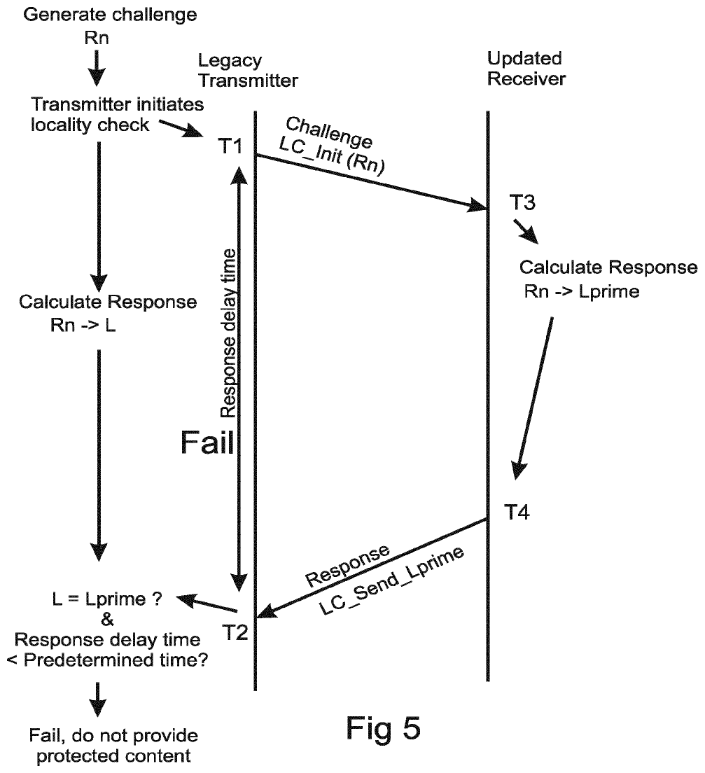

FIG. 5 shows a timing diagram of a locality check between a legacy transmitter and an updated receiver.

FIG. 5 shows the behavior of the legacy transmitter on the left and the updated receiver on the right.

The transmitter first generates a challenge, for instance a random number Rn, and at time T1 transmits this challenge to the receiver, for instance using the command LC_INIT comprising the Random number Rn. This challenge is received by the receiver at time T3 and the receiver's challenge response generator starts calculating a response. This response can for instance be a modification of the random number Rn using a secret that previously has been shared between the transmitter and the receiver. In parallel the transmitter will generate a local response by performing the same calculations as the receiver's challenge response generator. The receiver's challenge response generator calculates the response and this response is sent to the transmitter indicated by time T4 in FIG. 5 but since there is no requirement for a timely provision of the response the updated receiver can take more time than the legacy transmitter accepts. When the transmitter receives the response, for instance in the case of HDCP 2.3 in the form of LC_Send_Lprime, it compares the received response to the locally generated response. If the locally generated response and received response are identical the transmitter continues and provides the protected content to the receiver. The response provided by the receiver is likely to be late as the updated receiver does not have to adhere to a time requirement by updated transmitters as shown in FIG. 4 but in this configuration this causes problems. If the locally generated response and received response are not identical and/or the predetermined time has been exceeded, the transmitter retries the locality check by generating a new Rn and sending it a new challenge to the receiver. It will in this case not provide the protected content to the receiver.

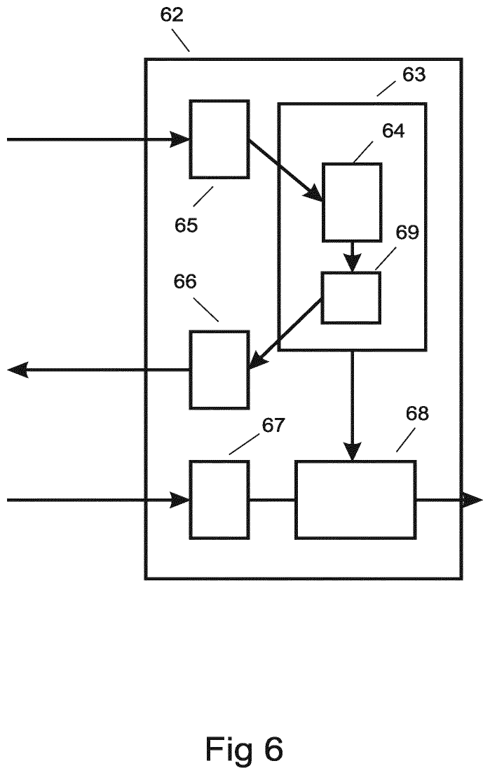

FIG. 6 shows a receiver according to the invention.

An receiver 22 according to the invention is arranged to receive protected content from a transmitter (not shown), updated or legacy, some transmitters imposing a maximum response delay time between sending a challenge to the receiver 62 according to the invention and receiving a response from the receiver 62 according to the invention while other transmitters don't impose such a predetermined time limit.

In order to be able to provide a response to the challenge the receiver 62 comprises a processor 63. This processor can be a general purpose processor with associated circuitry to control the receiver or can be, again with the required external circuitry, be arranged to control the challenge response process.

The processor 63 comprises a challenge response generator 64. This challenge response generator 64 receives from the receiver's communication receiver circuit 65 the challenge as transmitted by the transmitter the challenge for instance comprising a random number.

After receiving the challenge the challenge response generator 64 calculates a response. This response can for instance be a modification of the challenge received using a secret that is shared known to both transmitter and receiver 62. This calculation takes a certain amount of time, after which the challenge response generator 64 provides the response to a response delay control unit 69. This response delay control unit selects a delay from a range of delays and possibly selects this delay based on a desired frequency of occurrence distribution of the delays within the range of delays. The response delay control unit 69 then provides the response to the receiver's transmission communication circuit 66, which in turn transmits the response to the transmitter. The transmitter receives the response via transmitter's communication receiving circuit. While the challenge was sent to the updated receiver 62, the updated transmitter performed the same calculation as the updated receiver's 62 challenge response unit 64. The result of this local calculation performed in the transmitter is a locally generated response that is then provided just as well as the received response to a locality verification unit. This locality verification unit either only verifies that the locally calculated response is equal to the received response and does not check that the received response was received within a predetermined time or it verifies that the locally calculated response is equal to the received response and additionally does check that the received response was received within a predetermined time. Based on the verification performed by locality verification unit the protected content is then provided by the transmitter to the receiver 62 where it is received by the receiver's content receiver 67 which in turn provides the protected content to a decryptor 68 where the protected content is decrypted for further use.

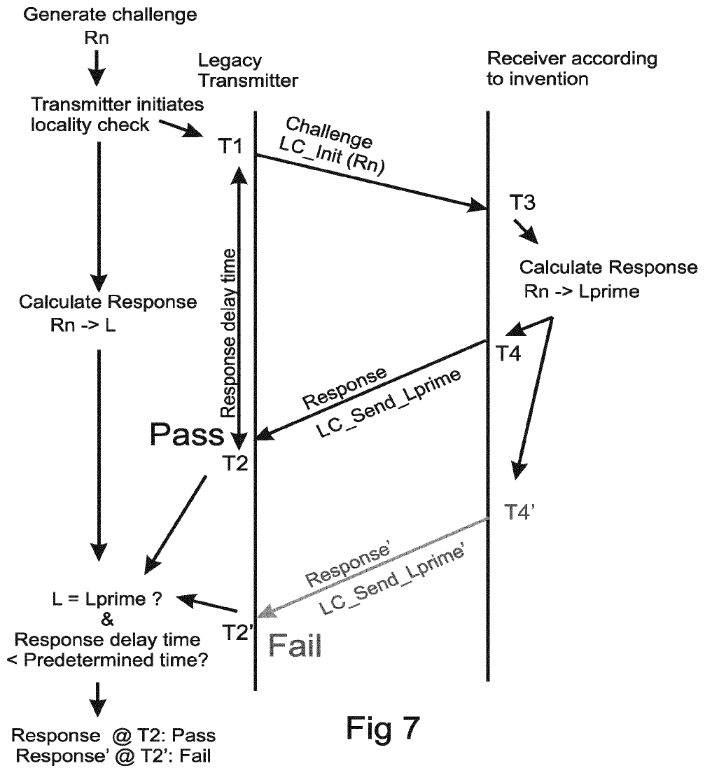

FIG. 7 shows a timing diagram of a locality check between a legacy transmitter and a receiver according to the invention.

FIG. 7 shows the behavior of the legacy transmitter on the left and receiver according to the invention on the right.

The transmitter first generates a challenge, for instance a random number Rn. and at time T1 transmits this challenge to the receiver according to the invention, for instance using the command LC_INIT comprising the Random number Rn. This challenge is received by the receiver at time T3 and the receiver's challenge response generator starts calculating a response. This response can for instance be a modification of the random number Rn using a secret that previously has been shared between the transmitter and the receiver. In parallel the transmitter will generate a local response by performing the same calculations as the receiver's challenge response generator. The receiver's challenge response generator calculates the response. Compared to the previous examples the receiver according to the invention however now introduces a response delay time as generated by the response delay control unit and after this delay this response is sent to the transmitter indicated at time T4 in FIG. 7. For subsequent challenges different response delay times are introduced. This will result in successive responses arriving earlier and later. The responses arriving late at a legacy transmitter will result in the legacy transmitter retrying by sending another challenge and there fore not stall the transmitter. Responses with a shorter response delay time will arrive in time at time T2 at the legacy transmitter to satisfy the predetermined time limit as imposed by HDCP 2.3 and protected content can be provided. It is no problem that the legacy transmitter has to retry as it introduces minimal delay. When the transmitter receives the response, for instance using the command LC_Send_Lprime, it compares the received response to the locally generated response. If the locally generated response and received response are identical the transmitter continues and provides the protected content to the receiver. If the locally generated response and received response are not identical and/or the predetermined time has been exceeded, the transmitter retries the locality check by generating a new Rn and sending it a new challenge to the receiver. It will in this case not provide the protected content to the receiver.

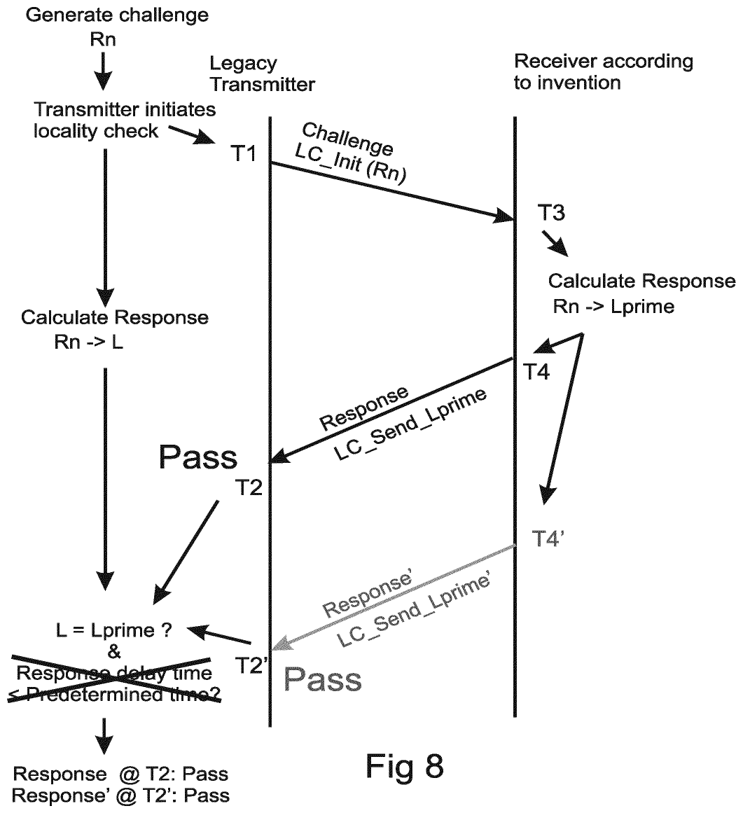

FIG. 8 shows a timing diagram of a locality check between an updated transmitter and a receiver according to the invention.

FIG. 8 shows the behavior of the updated transmitter on the left and receiver according to the invention on the right.

The transmitter first generates a challenge, for instance a random number Rn. and at time T1 transmits this challenge to the receiver, for instance using the command LC_INIT comprising the Random number Rn. This challenge is received by the receiver at time T3 and the receiver's challenge response generator starts calculating a response. This response can for instance be a modification of the random number Rn using a secret that previously has been shared between the transmitter and the receiver. In parallel the transmitter will generate a local response by performing the same calculations as the receiver's challenge response generator. The receiver's challenge response generator calculates the response. Compared to the previous examples there is however now a response delay time introduced as generated by the response delay control unit and after this delay this response is sent to the transmitter indicated at time T4 in FIG. 8. As this is te receiver according to the invention, for different challenges different response delay times are being introduced. This will result in responses arriving earlier and later. The responses arriving late at the updated transmitter will result in the updated transmitter still waiting until the response arrives. Arriving late is therefore no problem and the receiver according to the invention properly interacts with the updated transmitter and protected content can be provided. Responses with a shorter response delay time will arrive in time at the updated transmitter and also in this case protected content can be provided. When the transmitter receives the response it compares the received response to the locally generated response. If the locally generated response and received response are identical the transmitter continues and provides the protected content to the receiver. If the locally generated response and received response are not identical, the transmitter retries the locality check by generating a new Rn and sending it a new challenge to the receiver. It will in this case not provide the protected content to the receiver. As the updated transmitter does not impose a predetermined time limit a later received response still will allow the updated transmitter to provide the protected content.

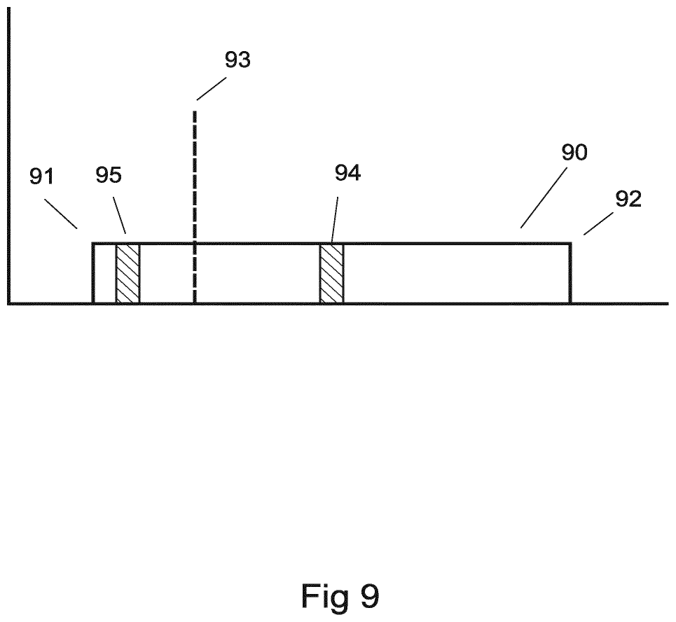

FIG. 9 shows a distribution of response times including a uniformly distribution of response delay times.

The horizontal axis the various response times 90 are depicted. The receiver according to the invention add a response delay time to the processing time needed for generating the response. Thus, a relatively fixed response time of the challenge response generator is changed into varying response time for the receiver according to the invention.

On the vertical axis the frequency of occurrence of each response time is depicted.

The varying response time ranges from a minimum response time 91 to a maximum response time 92. Also indicated is the predetermined time limit 93 as required by a legacy transmitter. The minimum response delay time is chosen to be below the maximum response delay time 93 (the predetermined time limit) imposed by the transmitter.

Having a range of response delay times providing different response delay times to chose from allows the receiver according to the invention to cooperate with both updated transmitters and legacy transmitters.

It is thus apparent that not all responses will arrive in time at the legacy transmitter. The responses with a short response time 95 will, when the response has correctly been calculated, be accepted by the legacy transmitter and protected content will be provided by the legacy transmitter. On the other hand a long response time 94 will, when the response has correctly been calculated, still be rejected by the legacy transmitter and protected content will not be provided by the legacy transmitter. The legacy transmitter however has the mechanism of retrying 1024 times so one of the successive retries will be answered with a shorter response time because the response delay control unit of the receiver according to the invention will statistically select response delay times from the available range, so a certain percentage of response delay times will lead to a response time that complies with the legacy receiver's predetermined time limit. Although a uniform distribution is shown for easy of discussion, any other distribution can be chosen, such as for example but not limited to a gaussian distribution or a binary distribution to name a few.

Choosing a second response delay time differing from a first response delay time by a random amount creates an even distribution of frequency of occurrence of the various response times.

It is self apparent that in case of an updated transmitter that lacks a predetermined time limit check, any of the response time values between the minimum response time 91 to a maximum response time 92 will allow the updated transmitter to function as desired.

The updated transmitter thus properly functions with both the updated receiver as well as the receiver according to the invention. Where as the updated receiver may have issues when used in combination with legacy transmitters, the receiver according to the invention will properly operate with both updated transmitters and legacy transmitters. Another option (not shown) is a gaussian distribution. Such a gaussian distribution can be positioned so that the peak occurrence in response times coincides with a response time that optimally works with the majority of transmitters in the field at a given moment. The distribution may be adjusted so as to accommodate shifts in use of a predetermined time in a locality check by transmitters in the field. A predetermined percentage of response delay times can be chosen to be below the maximum response delay time imposed by transmitters in the field.

This distribution can also be used to discourage use of non-official transmitters by reducing the frequency of occurrence of suitable response times for those transmitters.

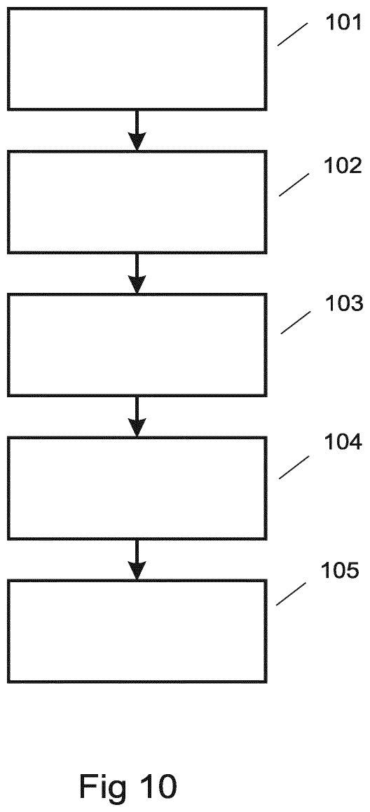

FIG. 10 shows the steps of a receiver method according to the invention.

In the method to receive protected content from a transmitter where the transmitter imposes a maximum response delay time between sending a challenge and receiving a response, there are the steps of
receiving 101 a challenge from the transmitter
generating 102 a response,
controlling 103 the response delay time.
transmitting 104 the response to transmitter after a response delay time
and receiving 105 the protected content from the transmitter.

In the step of controling the response delay time 103 a first response is associated with a first response delay time and a second response is associated with a second response delay time, the first and second response delay times differing from each other.

Another measure taken in this step 103 is that the second response delay time differs the first response delay time by a minimum amount.

An alternative is that in step 103 the second response delay time differs the first response delay time by a random amount or that a distribution of response delay times is a gaussian distribution.

The controlling step 103 could further have the response delay time that is between a minimum response delay time and a maximum response delay time.

In order to make sure that the method is also compatible with legacy transmission methods the minimum response delay time is kept below the maximum response delay time imposed by the transmitter. To steer the compatibility in line with the remaining installed base of legacy transmitters in the field a predetermined percentage of response delay times is below the maximum response delay time imposed by the legacy transmitters in the field.

### DEFINITION OF TERMS

In this description the following terms mean the following:
Legacy transmitter: a transmitter adhering to an earlier specification.
Legacy receiver: a receiver adhering to an earlier specification.
Updated transmitter: a transmitter adhering to a later version of the earlier specification or adhering to an errata of such an earlier specification.

Updated receiver: a receiver adhering to a later version of the earlier specification or adhering to an errata of such an earlier specification.

It is further to be noted that a receiver according to the invention has been described using the HDCP specification because this specification is well understood by the person skilled in the art and publicly available. This does however not imply that this invention is limited to this specification. Other data transmission specifications have locality checks that impose a time constraint on the response to a challenge and the present invention can be used for receivers for these specifications as well.

1. A receiver the receiver comprising:
a processor circuit;
a communication receiver circuit, wherein the communication receiver circuit is arranged to receive a challenge from a transmitter, and
a communication transmitter circuit, wherein the communication transmitter circuit is arranged to return a response to the transmitter,
wherein the processor circuit is arranged to receive the challenge from the communication receiver circuit,
wherein the processor circuit is arranged to generate the response,
wherein the processor circuit is arranged to send the response to the communication transmitter circuit after a response delay time,
wherein the processor circuit is arranged to to control the response delay time.

2. The receiver as claimed in claim 1,
wherein a first response is associated with a first response delay time,
wherein a second response is associated with a second response delay time,
wherein the first response delay time is different from the second response delay times.

3. The receiver as claimed in claim 2, wherein the second response delay time differs from the first response delay time by a minimum amount.

4. The receiver as claimed in claim 2, wherein the second response delay time differs from the first response delay time by a random amount.

5. The receiver as claimed in claim 4, wherein a distribution of response delay times is a Gaussian distribution.

6. The receiver as claimed in claim 2, wherein the response delay time is between a minimum delay time and a maximum delay time.

7. The receiver as claimed in claim 6,
wherein the minimum delay time is less than a transmitter maximum response delay time,
wherein the transmitter maximum response delay time is imposed by the transmitter.

8. The receiver as claimed in claim 7, wherein a portion of response delay times is below the transmitter maximum response delay time.

9. The method comprising:
receiving a challenge from a transmitter,
generating a response;
transmitting the response to transmitter after a response delay time; and
controlling the response delay time.

10. A method as claimed in claim 9,
wherein a first response is associated with a first response delay time,
wherein a second response is associated with a second response delay time,
wherein the first response delay time is different from the second response delay times.

11. The method as claimed in claim 10, wherein the second response delay time differs from the first response delay time by a minimum amount.

12. The method as claimed in claim 10, wherein the second response delay time differs from the first response delay time by a random amount.

13. The method as claimed in claim 10, wherein a distribution of response delay times is a gaussion distribution.

14. The method as claimed in claim 10, wherein the response delay time is between a minimum delay time and a maximum delay time.

15. The method as claimed in claim 10,
wherein the minimum delay time is less than a transmitter maximum response delay time,
wherein the transmitter maximum response delay time is imposed by the transmitter.

16. The method as claimed in claim 15, wherein a portion of response delay times is below the transmitter maximum response delay time.

17. The computer program stored on a non-transitory medium, wherein the computer program when executed on a processor performs the method as claimed in claim 9.

18. (canceled)
